(19) United States
(12) Patent Application Publication
(10) Pub. No.: US 2026/0360019 A1
(43) Pub. Date: Nov. 12, 2026

(54) METHOD AND APPARATUS FOR 3D VIDEO CODING BASED ON IMPLICIT NEURAL NETWORK REPRESENTATION

(71) Applicants: Hyundai Motor Company, Seoul (KR); Kia Corporation, Seoul (KR); Ewha University - Industry Collaboration Foundation, Seoul (KR)

(72) Inventors: Je Won Kang, Seoul (KR); Jung Kyung Lee, Seoul (KR); Ji Hoo Lee, Seoul (KR); Ju Yeon Shin, Seoul (KR); Jung Ah Choi, Seoul (KR); Jin Heo, Yongin-si (KR); Seung Wook Park, Yongin-si (KR)

(21) Appl. No.: 19/487,189

(22) PCT Filed: May 13, 2024
(86) PCT No.: PCT/KR2024/006487

§ 371 Date: Nov. 24, 2025

(30) Foreign Application Priority Data
May 23, 2023 (KR) 10-2023-0066090
May 9, 2024 (KR) 10-2024-0061136

(51) Int. Cl. G06T 9/00; H04N 19/597; H04N 19/70

(52) U.S. Cl. CPC G06T 9/002; H04N 19/597; H04N 19/70

(57) ABSTRACT

A method and an apparatus are disclosed for 3D video based on an implicit neural network representation. In the disclosed embodiments, the video decoding apparatus decodes from a bitstream, parameters of a 3D implicit neural video representation model (3D INVR model) and an INVR parameter set (IPS). Here, the IPS set comprises a quantization parameter, information on a structure of the 3D INVR model, and information on an input range of the 3D INVR model. The video decoding apparatus reconstructs the 3D INVR model by using the parameters of the 3D INVR model and the quantization parameter to conform to the information on the structure of the 3D INVR model. The video decoding apparatus obtains an arbitrary view point from within the input range, and generates the current 3D video by inputting the arbitrary view point to the 3D INVR model.

### TECHNICAL FIELD

The present disclosure relates to a 3D video coding method and an apparatus based on an implicit neural network representation.

### BACKGROUND

The statements in this section merely provide background information related to the present disclosure and do not necessarily constitute prior art.

Research on implicit neural representation models, which express various data including images by neural network structures, is currently active. As an existing video representation scheme, an explicit representation scheme having RGB pixel values at each pixel location is employed. To replace this explicit representation scheme, implicit neural representation schemes are being introduced, which provide a neural network representation of a function that generates (r,g,b) values at the (x,y) coordinates of an image's pixel location.

Among the implicit neural representation schemes, Neural Radiance Fields (NeRF) technology exists as a representative model used for synthesizing three-dimensional video (3D video). By utilizing a learning process for reconstructing all pixels within an image in a world coordinate system, NeRF outputs the rendered result at an arbitrary view point. In doing so, NeRF uses as input the indices in the world coordinate system and the camera parameters required for projection into the world coordinate system. Therefore, to increase 3D video coding efficiency and enhance 3D video quality, there is a need for methods of efficiently constructing implicit neural representation-based 3D video representation models.

### DISCLOSURE

### Technical Problem

The present disclosure seeks to provide a 3D video coding method and an apparatus that generate, compress, and transmit parameters of the 3D implicit neural video representation model (3D INVR model). The 3D video coding method and the apparatus generate and transmit camera parameters for improving the quality of any view point requested by the decoder side, as well as supplementary information for improving the compression of the 3D INVR model.

The present disclosure also seeks to provide a 3D video coding method and an apparatus that generate supplementary information for improving the compression of the 3D INVR model by adaptively varying the quantization parameter for compressing the 3D INVR model and the complexity according to the 3D INVR model structure.

### Technical Solution

At least one aspect of the present disclosure provides a method for reconstructing a current three-dimensional (3D) video by a video decoding apparatus. The method includes decoding, from a bitstream, parameters of a 3D implicit neural video representation model (3D INVR model) and an INVR parameter set (IPS). Here, the IPS set comprises a quantization parameter, information on a structure of the 3D INVR model, and information on an input range of the 3D INVR model. The method also includes reconstructing the 3D INVR model by using the parameters of the 3D INVR model and the quantization parameter to conform to the information on the structure of the 3D INVR model. Here, the 3D INVR model comprises a multi-layer perceptron (MLP) and a convolutional neural network (CNN). The method also includes obtaining an arbitrary view point from within the input range. The method also includes generating the current 3D video by inputting the arbitrary view point to the 3D INVR model.

Another aspect of the present disclosure provides a method for encoding three-dimensional (3D) videos by a video encoding apparatus. The method includes obtaining the 3D videos and camera parameters corresponding to the 3D videos. The method also includes constructing a 3D implicit neural video representation model (3D INVR model) that comprises a multi-layer perceptron (MLP) and a convolutional neural network (CNN). The method also includes training the 3D INVR model by using view points corresponding to the camera parameters and using 3D videos corresponding to the camera parameters. The method also includes determining an input range of the 3D INVR model based on the view points used for the training. The method also includes determining a quantization parameter and information on a structure of the 3D INVR model based on results of the training. The method also includes encoding parameters of the 3D INVR model by using the quantization parameter. The method also includes encoding an INVR parameter set (IPS) that comprises the quantization parameter, the information on the structure of the 3D INVR model, and information on the input range of the 3D INVR mode.

Yet another aspect of the present disclosure provides a method for providing video data to a video decoding apparatus. The method includes encoding the video data into a bitstream, and transmitting the bitstream to the video decoding apparatus. The encoding of the video data includes obtaining 3D videos and camera parameters corresponding to the 3D videos. The encoding of the video data also includes constructing a 3D implicit neural video representation model (3D INVR model) that comprises a multi-layer perceptron (MLP) and a convolutional neural network (CNN). The encoding of the video data also includes training the 3D INVR model by using view points corresponding to the camera parameters and using 3D videos corresponding to the camera parameters. The encoding of the video data also includes determining an input range of the 3D INVR model based on the view points used for training. The encoding of the video data also includes determining a quantization parameter and information on a structure of the 3D INVR model based on results of the training. The encoding of the video data also includes encoding parameters of the 3D INVR model by using the quantization parameter. The encoding of the video data also includes encoding an INVR parameter set (IPS) that comprises the quantization parameter, the information on the structure of the 3D INVR model, and information on the input range of the 3D INVR model.

### Advantageous Effects

As described above, the present disclosure provides a 3D video coding method and an apparatus that generate, compress, and transmit parameters of the 3D INVR model. The 3D video coding method and the apparatus generate and transmit camera parameters for improving the quality of any view point requested by the decoder side, as well as supplementary information for improving the compression of the 3D INVR model. Thus, the 3D video coding method and the apparatus increase 3D video coding efficiency and enhance 3D video quality during the video generation process at any desired view point.

In addition, according to another embodiment, the present disclosure provides a 3D video coding method and an apparatus that generate supplementary information for improving the compression of the 3D INVR model by adaptively varying the quantization parameter for compressing the 3D INVR model and the complexity according to the 3D INVR model structure. Thus, the 3D video coding method and the apparatus increase 3D video coding efficiency and enhance 3D video quality

### BRIEF DESCRIPTION OF THE DRAWINGS

FIG. 1 is a block diagram illustrating a 3D implicit neural video representation-based (INVR-based) 3D video encoding apparatus according to at least one embodiment of the present disclosure.

FIG. 2 is a block diagram illustrating a 3D INVR-based 3D video decoding apparatus according to at least one embodiment of the present disclosure.

FIG. 3 is a diagram illustrating the operation of a convolution layer according to at least one embodiment of the present disclosure.

FIG. 4 is a diagram illustrating a single image super resolution (SISR) network.

FIG. 5 is a diagram illustrating a residual block utilized in SISR.

FIG. 6 is a diagram illustrating coordinate systems related to extraction of arbitrary view points by Neural Radiance Fields (NeRFs).

FIG. 7 is a diagram illustrating a Neural Representations for Videos model (NeRV model).

FIGS. 8A and 8B are diagrams illustrating the concept of a NeRV model according to at least one embodiment of the present disclosure.

FIG. 9 is a diagram illustrating an encoding pipeline of a NeRV model, according to at least one embodiment of the present disclosure.

FIG. 10 is a diagram illustrating a decoding pipeline of a NeRV model, according to at least one embodiment of the present disclosure.

FIG. 11 is a diagram illustrating pruning by using a bit mask, according to at least one embodiment of the present disclosure.

FIG. 12 is a diagram illustrating warping of a reference image, according to at least one embodiment of the present disclosure.

FIG. 13 is a diagram illustrating warping of a reference image/feature, according to at least one embodiment of the present disclosure.

FIG. 14 is a diagram illustrating the definition of a Group of INVR (Gol) according to at least one embodiment of the present disclosure.

FIG. 15 is a flowchart of a method of encoding 3D videos by a video encoding apparatus, according to at least one embodiment of the present disclosure.

FIG. 16 is a flowchart of a method of reconstructing the current 3D video by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

The present disclosure relates to the encoding and decoding of 3D images (3D video). More specifically, the present disclosure provides a 3D video coding method and an apparatus provide 3D video coding methods and apparatuses that generate, compress, and transmit parameters of the 3D implicit neural video representation model (3D INVR model). The 3D video coding method and an apparatus generate and transmit camera parameters for improving the quality of any view point requested by the decoder side, as well as supplementary information for improving the compression of the 3D INVR model.

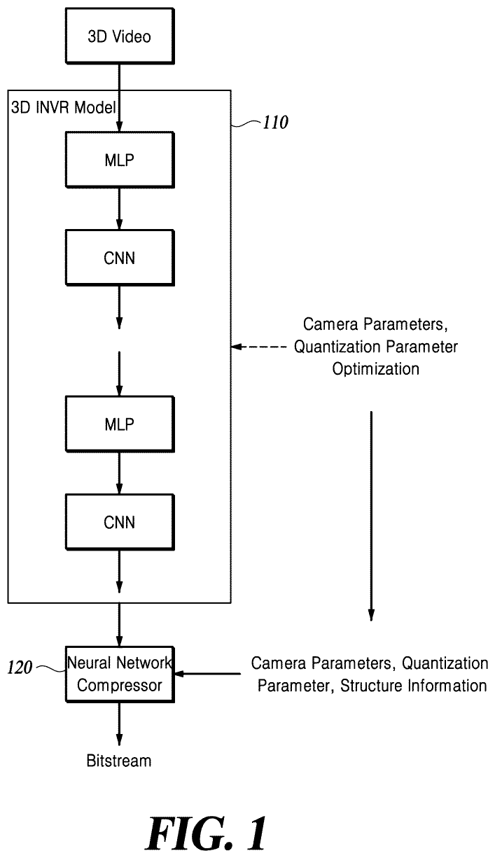

FIG. 1 is a block diagram illustrating a 3D INVR-based 3D video encoding apparatus according to at least one embodiment of the present disclosure.

In the example of FIG. 1, the 3D INVR-based 3D video encoding apparatus (hereinafter, ‘video encoding apparatus’) generates, i.e., trains a 3D INVR model to learn how to generate 3D video from various view points, compresses the learned 3D INVR model to generate a bitstream, and transmits the generated bitstream. The video encoding apparatus includes a 3D INVR encoder 110 containing the 3D INVR model and a neural network compressor 120. Here, these are not necessarily the only components of the video encoding apparatus according to the present disclosure. The video encoding apparatus may further include a trainer (not shown) for training the 3D INVR model, or may be implemented in a form that interworks with an external trainer.

Each component of the video encoding apparatus may be implemented in hardware or software, or in hardware and software combined. Furthermore, the functions of each component may be implemented in software, with the microprocessor executing the corresponding software functions to each component.

The video encoding apparatus may store the bitstream of the encoded video data on a non-volatile storage medium or transmit it to a 3D INVR-based 3D video decoding apparatus via a communication network.

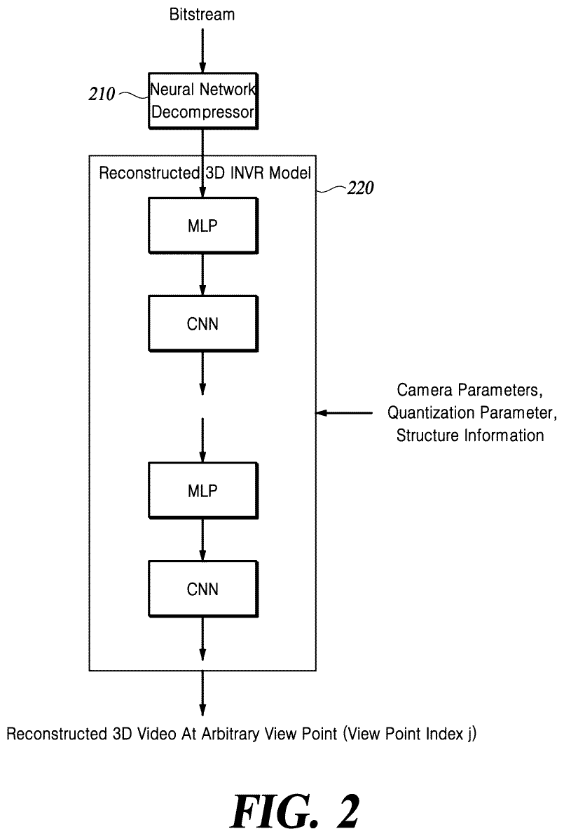

FIG. 2 is a block diagram illustrating a 3D INVR-based 3D video decoding apparatus according to at least one embodiment of the present disclosure.

In the example of FIG. 2, the 3D INVR-based 3D video decoding apparatus (hereinafter referred to as the ‘video decoding apparatus’) decompresses the bitstream to reconstruct the 3D INVR model and uses the same to generate 3D video from various view points. The video decoding apparatus includes a neural network decompressor 210 and a 3D INVR decoder 220 that includes the reconstructed 3-dimensional INVR model.

Similar to the video encoding apparatus illustrated in FIG. 1, each component of the video decoding apparatus may be implemented in hardware or software, or in hardware and software combined. Furthermore, the functions of each component may be implemented in software, with a microprocessor executing the corresponding software functions to each component.

Before describing the components illustrated in FIGS. 1 and 2, the deep learning-related element technologies used in the present disclosure are described below.

### I. Convolutional Neural Network (CNN)

CNN refers to a neural network composed of a plurality of convolutional layers and pooling layers and is a deep learning technique known to be best suited for image processing. The convolutional layer uses a plurality of kernels or filters to extract a feature map, also referred to as a ‘feature’. The kernel coefficients that constitute the filters are the parameters that are determined during the learning process.

Among the convolutional layers of the CNN, a frontend layer close to the input extracts feature maps that respond to simple, low-level image features such as lines, points, or faces. Among the convolutional layers of the CNN, a backend layer close to the output extracts feature maps that respond to higher-level features such as textures and object parts.

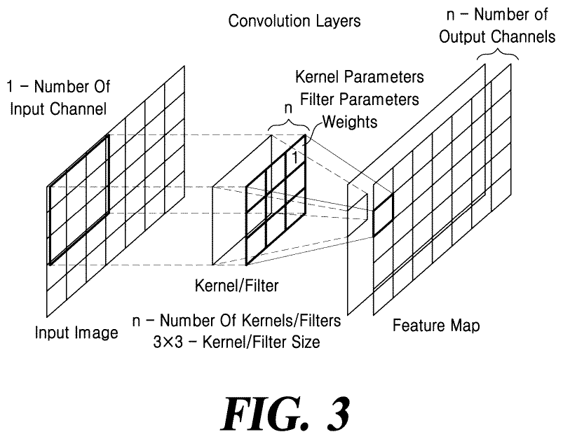

FIG. 3 is a diagram illustrating the operation of a convolutional layer, according to at least one embodiment of the present disclosure.

The convolutional layer utilizes a convolutional operation to generate a feature map from the input image. The example of FIG. 3 depicts a kernel (or filter) with a kernel size of 3×3. The kernel size is also referred to as the filter size. The kernel has a kernel parameter or filter parameter, also referred to as a weight. The kernel illustrated in FIG. 3 has a total of nine kernel parameters. The kernel parameters may be initially set to random values, and their values may be updated based on training.

The convolutional layer performs a convolutional operation by using a block equal to the kernel size in the input image. In this case, the block equivalent to the kernel size in the input image is referred to as a window.

When filtering the input image is performed in a raster-scan order, the amount of the movement of the window is called a stride. In the example of FIG. 3, the stride is 1. If the stride is set to 2, the convolutional operation is performed shifting the window by 2 samples, resulting in the horizontal and vertical dimensions of the feature map being half the horizontal and vertical dimensions of the input image.

As mentioned above, a convolutional layer may include a plurality of filters. The number of filters or the number of kernels is referred to as the number of channels. Namely, the number of channels is equal to the number of filters. The number of filters also determines the dimensionality of the feature map.

Padding refers to a method of expanding the input data by filling in a certain value around the input data before performing a convolutional operation. Padding is often used to control the spatial size of the output data. The value used for padding may be determined by hyperparameters, but zero padding is commonly used. If no padding is used, the spatial size of the output data decreases with each pass through the convolutional layer, which may cause boundary information to be lost. Thus, to avoid this issue, padding is used. Padding can be used to equalize the spatial size of the convolutional layer's output data and input data.

The deconvolutional layer performs the opposite operation of the convolutional layer. The deconvolutional layer generates a desired data image as an output from a feature map which is an input.

The pooling layer performs pooling, which is the process of subsampling the feature map generated by the convolutional layer. The pooling layer utilizes a 2×2 window to select samples such that the output is half the width and half the height of the input. In other words, the pooling layer is utilized to reduce the size of the input image or input feature map by condensing a 2×2 region into a single sample.

The opposite of a pooling layer is defined as an unpooling layer. An unpooling layer serves to increase dimensionality as opposed to a pooling layer and is typically used after a deconvolutional layer.

A convolutional encoder-decoder structure is a network structure composed of pairs of convolutional and deconvolutional layers. A convolutional encoder is composed of a convolutional layer and a pooling layer to output a feature map (or feature vector) from an input image. The final output vector of a convolutional encoder is also referred to as a latent vector. A convolutional decoder is composed of a deconvolutional layer and an unpooling layer to generate an output image from the feature map or latent vector.

The inputs and outputs of the convolutional encoder-decoder may vary depending on the purpose of the application and network. For example, the inputs and outputs may be optical flow maps, saliency maps, image frames, or the like.

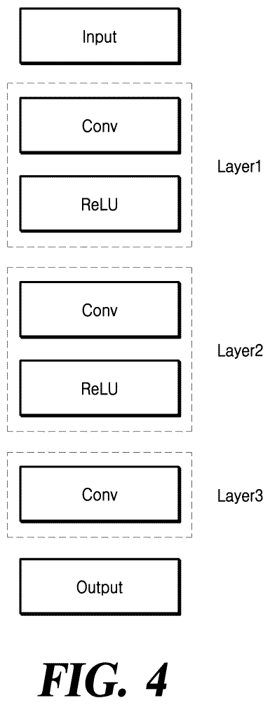

FIG. 4 is a diagram illustrating a single image super resolution network (SISR network).

One example application of CNN is Single Image Super Resolution (SISR). A SISR network generates a high-resolution output image from a low-resolution input image. A SISR network may include multiple convolutional layers, as illustrated in FIG. 4. Each convolutional layer includes an activation function, such as a Rectified Linear Unit (ReLU). The parameters of the SISR network may be trained such that the resulting super-resolution (SR) image is close to the ground truth (GT).

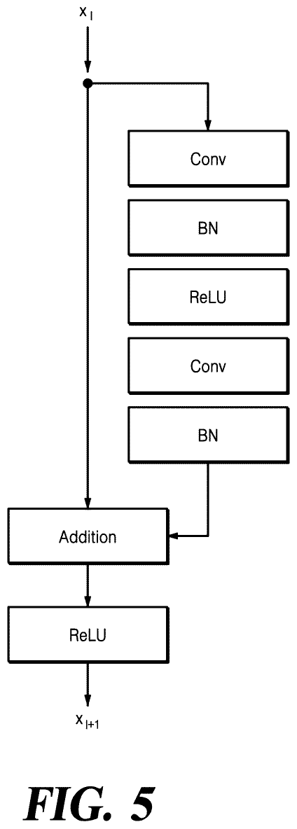

SR methods using CNNs can improve SR performance by increasing the depth, e.g., by increasing the number of convolutional layers. To overcome the problem of overfitting in learning, which may occur with increasing depth, the SISR network may utilize a residual block that may perform skip connections and residual learning. As illustrated in FIG. 5, the residual block includes a skip path in addition to a path for applying a convolutional operation to the input feature xl. In addition, the residual block when generating the output xl+1 may select the path of applying the convolutional operation based on learning efficiency or the skip path. In the example of FIG. 5, the residual block includes a batch normalization (BN) layer.

In one example, Enhanced Deep residual networks for SISR (EDSR) enhance the performance of the network by increasing the depth by concatenating residual blocks in succession. Another example is Accurate Image Super-Resolution Using Very Deep Convolutional Networks (VDSR), a CNN model based on Visual Geometry Group networks (VGG networks) that uses residual learning, which is the addition of residual frames to the final output. VDSR adds the residual signal at the very end of the network and thereby adds the residual signal to the input signal.

### II. Implicit Neural Representation Model

Recently, there has been active research on implicit neural representation models that represent various data including images in a neural network structure. A conventional video representation scheme used is an explicit representation scheme with RGB pixel values represented for each pixel position. To replace this explicit representation scheme, an implicit neural representation model is newly introduced, representing a function by a neural network for converting the (x,y) coordinates of the video pixel position into (r,g,b) values. Compared to the explicit representation scheme, the implicit neural representation model can be used regardless of the resolution of the images.

As an example of 3D video coding using an implicit neural representation model, Neural Radiance Fields (NeRF) technology exists.

By learning images captured from multiple view points of multi-view video, NeRF synthesizes the images of an object as seen from arbitrary positions and directions. Upon receiving an input of five-dimensional coordinates composed of a 3D position (x, y, z) and a viewing direction (θ, φ) from sampling the ray information of the camera's viewing direction, NeRF outputs the input coordinates' corresponding RGB values (r, g, b) and volume density σ. Here, the 3D position (x, y, z) is the position in the world coordinate system, and θ and φ, which constitute the viewing direction, may represent the azimuth and elevation, respectively.

Compared to existing implicit neural representation schemes, NeRF has the following improvements to better represent high-resolution complex scenes. NeRF embeds positional information by using positional encoding and then uses the embedded indices as input, as shown in Equation 1.

γ(p)=(sin(2⁰πp),cos(2⁰πp), . . . ,sin(2^{L-1}πp), cos(2^{L-1}πp) [Equation 1]

As illustrated in Equation 1, each spatial coordinate may be mapped to a 2L-dimensional vector γ(p). Instead of directly inputting 3D coordinates, each spatial coordinate may be mapped to a 2L-dimensional vector γ(p) by using sin and cos functions. By utilizing the embedded spatial indices for training the NeRF model, the NeRF model can better predict data containing high-frequency variations.

NeRF, as an implicit neural representation model, uses a multi-layer perceptron (MLP) network containing multiple fully-connected layers (FC). NeRF represents an arbitrary scene by outputting RGB values (r, g, b) and volume density σ corresponding to the high-dimensional input coordinates. Subsequently, by using volume rendering techniques based on the RGB values (r, g, b) and volume density σ, rendering may be performed on the color C(r) of an arbitrary ray r passing through the scene. Since C(r) is differentiable, it is used for training NeRF alongside the ground truth (GT). Here, GT used for each 5-dimensional coordinate is an image from world coordinates (x,y,z) captured along the viewing direction (θ, φ).

Meanwhile, to increase rendering efficiency, NeRF incorporates two networks—a coarse network and a fine network—instead of using a single MLP. NeRF samples a number N_{c} of locations by using stratified sampling and then computes the output of the coarse network at these N_{c} locations. To generate more samples for the fine network based on the coarse network output, a composite color Cc(r) is expressed as in Equation 2 based on the N_{c} coarse network outputs.

$${C}_{c} ( r ) = {\sum }_{i = 0}^{{N}_{c}} {w}_{i} {c}_{i} \qquad [ Equation 2 ]$$

In Equation 2, cᵢ is the color of the coarse network calculated at N_{c} locations. wᵢ is the corresponding weight, a value dependent on the volume and the distance between the sampled locations. By using inverse transform sampling, NeRF samples N_{f} positions with high weights from the above-described composite color. It then computes the output of the fine network at N_{c}+N_{f} positions and renders the color C_{f}(r) based on the computed fine network output. At this point, NeRF may be trained by using a mean square error (MSE) loss function between the ground truth (GT) and the colors derived from the outputs of the coarse and fine networks.

As described above, NeRF uses the learning process to reconstruct all pixels in an image into a world coordinate system to output rendered results at arbitrary view points. This requires the process of transforming all points projected onto a single point in the image coordinate system (x, y) into the world coordinate system, so the input to NeRF includes the index in the world coordinate system along with the camera parameters necessary for projection into the world coordinate system.

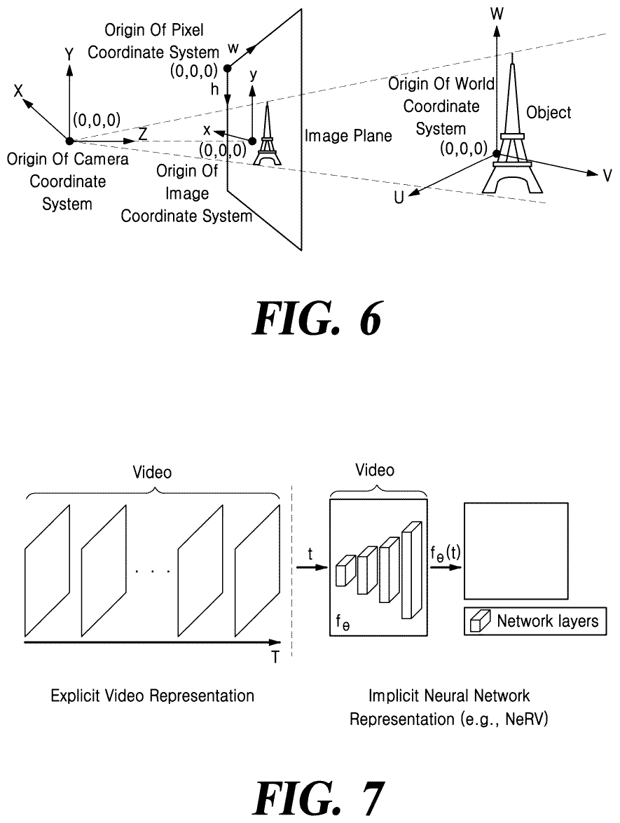

The process of extracting camera parameters involves transforming pixels within the image via the coordinate system [X, Y, Z] with focal length Z=−1 to the world coordinate system [U, V, W], as illustrated in FIG. 6. At this time, prior information on the camera is essential. As prior information, the camera parameters include internal parameters and external parameters. The camera's internal parameters include the focal length, the principal point on the image plane, and the skew coefficient. Based on these internal parameters, the object may be projected into the camera coordinate system [X, Y, Z]. To transform the information projected into the camera coordinate system into the world coordinate system [U, V, W], translation information on where the camera is located within the world coordinate system and rotation information on where it is facing are required. The camera's external parameters include the above-described translation information and rotation information. When capturing an image, the combined matrix [R|t], composed of the rotation matrix R and the translation vector t, is used to compute the projection from the world coordinate system to the image coordinate system. Therefore, the camera's external parameters may be extracted by calculating the inverse of the combined matrix [R|t].

Meanwhile, the 5-dimensional coordinates, which is the input to NeRF, may be derived from the extracted camera parameters. As described above, the camera parameters may be derived based on the captured 2D image and its corresponding positions within the world coordinate system. When capturing images for use as ground truth (GT), the camera's internal parameters may be fixed. When the camera's internal parameters are used in a fixed state, the 5-dimensional coordinates may be derived from the camera's external parameters.

As another example, besides using the camera parameters employed during image capture, a method may also be used that reconstructs information on the camera's position and direction within the world coordinate system by extracting feature points from multi-view images, such as colmap.

As an example of two-dimensional video coding using the implicit neural representation model, there exists implicit neural representation-based video coding (Implicit Neural Representation for Video Coding or INRVC). The INRVC technique generates (r,g,b) values for the (x,y) coordinates representing the pixel positions in an image. As an example of INRVC technology, the Neural Representation for Video model (NeRV model) exists. As mentioned above, the explicit representation scheme represents pixel values on an (x,y,t) grid by using the pixel position (x,y) in the image and the time index t of the frame. The implicit neural representation model outputs RGB pixel values from an input representing the position in (x,y,t). However, training a neural network at every position in (x,y,t) can significantly increase the computational complexity, so the NeRV model outputs the RGB image of the entire frame at time index t by using a neural network structure with only time index t used as input, as illustrated in FIG. 7.

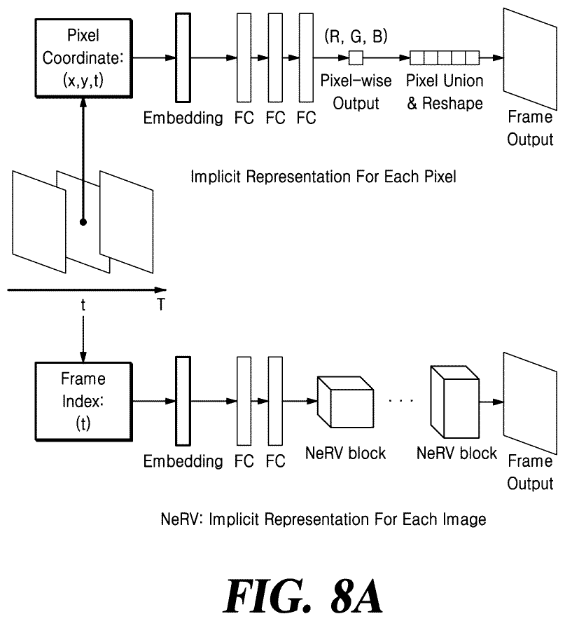

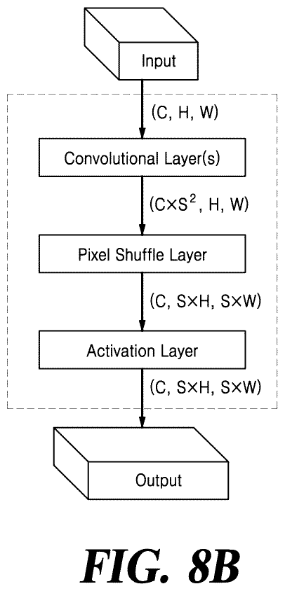

FIGS. 8A and 8B are diagrams illustrating the concept of a NeRV model according to at least one embodiment of the present disclosure.

To facilitate providing image output for a time index t input, utilizing convolutional layers can be more effective than to utilize the existing implicit representation model's MLP (multi-layer perceptron) networks. The NeRV model may utilize a stacked structure of NeRV blocks composed of multiple convolutional layers to generate output. As illustrated in FIG. 8A, an MLP-based output and a NeRV block-based output may be compared. The NeRV block includes convolution layers performing convolutions, a pixel shuffle layer, and an activation layer, as illustrated in FIG. 8B. In the example of FIG. 8B, C denotes the number of channels, W and H denote the width and height of the input of the NeRV block, and S denotes the upscaling factor.

Further, the NeRV model embeds time index t into a higher dimensional space and uses the embedded index as an input, as shown in Equation 3.

γ(t)=(sin(2⁰πt),cos(2⁰πt), . . . ,sin(2_{L-1}πt),cos(2^{L-1}πt))

As illustrated in Equation 3, time index t may be mapped to a 2L-dimensional vector γ(t). By utilizing the embedded time index t in the training of the NeRV model, the NeRV model can better predict video data containing high-frequency variations.

As a loss function of the NeRV model, a combination of L1 loss and a structural similarity index loss (SSIM loss) may be used. During training of the NeRV model, these losses may be calculated at all pixel locations in the image estimated by the NeRV model based on the input and in the ground-truth (GT) image, i.e., the original image. The L1 loss is calculated by using the absolute value of the difference between the pixels in the estimated image and the GT image. The SSIM loss is calculated based on the mean, standard deviation, and correlation of the pixels in the estimated image and the GT image. Based on the calculated losses and during the training process, the weights (or parameters) that constitute the NeRV model may then be updated.

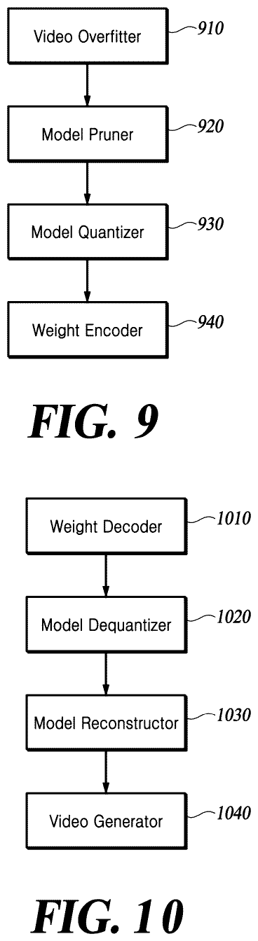

FIG. 9 is a diagram illustrating an encoding pipeline of a NeRV model, according to at least one embodiment of the present disclosure.

Since the NeRV model may be used to approximate the original video, compressing and transmitting the NeRV model can implement end-to-end compression techniques using neural networks. An encoding pipeline for encoding the NeRV model may include all or part of a video overfitter 910, a model pruner 920, a model quantizer 930, and a weight encoder 940, as illustrated in FIG. 9.

The video overfitter 910 represents the input video frames by the NeRV model. The video encoding apparatus trains the NeRV model by using the loss function described above to cause the NeRV model to represent the video frame. The model pruner 920 uses pruning to simplify the NeRV model structure which may be an MLP (multi-layer perceptron) or a mixture of the MLP and convolutional layers. For example, pruning sets weights smaller than a preset threshold to zero. The model quantizer 930 quantizes the pruned weights, e.g., weights greater than or equal to the threshold. The weight encoder 940 applies entropy encoding to the quantized weights to generate a bitstream of weights.

A reverse order of the encoding pipeline illustrated in FIG. 9, the decoding pipeline for decoding the NeRV model may be illustrated as in FIG. 10. The decoding pipeline may include all or part of a weight decoder 1010, a model dequantizer 1020, a model reconstructor 1030, and a video generator 1040, as illustrated in FIG. 10.

The weight decoder 1010 applies entropy encoding to the bitstream of weights of the NeRV model to generate quantized weights. The model dequantizer 1020 de-quantizes the quantized weights to generate pruned weights. The model reconstructor 1030 reconstructs the NeRV model based on the pruned weights. The video generator 1040 uses the reconstructed NeRV model according to the time index to generate reconstructed video frames.

As described above, the NeRV model utilizes the time index t of a frame as input. Thus, with a video inputted having pixels of size txhxw, the NeRV model samples the input video only t times instead of txhxw times, which may result in significant gains in both encoding and decoding speed.

Meanwhile, the encoding pipeline and decoding pipeline described above may also be used for the compression and reconstruction of the 3D INVR model.

Hereinafter, the 3D INVR model and the INVR model are used interchangeably.

### III. Embodiments According to the Present Disclosure

The video encoding apparatus illustrated in FIG. 1 trains the 3D INVR model within the 3D INVR encoder 110 by using 3D video with diverse view points and thereby enables the 3D INVR model to generate 3D video from various view points. Here, information representing various view points is used as input to the 3D INVR model, and an image corresponding to each view point is used as ground truth (GT). A trainer is provided to use the difference between the model's output and the GT to update the parameters (weights) of the 3D INVR model, thereby training the INVR model to generate 3D video from various view points. The learned 3D INVR model may contain 3D spatial information obtained by the 3D video based on the model's internal parameters. Hereafter, the information representing the view point used as input is referred to as the view point index.

The neural network compressor 120 compresses the parameters of the learned 3D INVR model to generate a bitstream. For example, the 3D INVR model may be compressed by using the encoding pipeline shown in FIG. 9. The video encoding apparatus transmits the generated bitstream to the video decoding apparatus.

The neural network structure of the 3D INVR model may be implemented by using NeRF, adding an additional neural network model to NeRF, or modifying part of NeRF. For example, NeRF may be implemented as an MLP as described above. Alternatively, NeRF may be composed of an MLP and a CNN combined. In this case, NeRF may include repeated combinations of the MLPs and CNNs.

When using a NeRF-based 3D INVR model, the video encoding apparatus uses the above-described 5-dimensional coordinates as the input index. Furthermore, for each 5-dimensional coordinate, GT used is an image from world coordinates (x,y,z) captured along the viewing direction (θ, φ). As described above, the 5-dimensional coordinates may be calculated from the camera parameters corresponding to the GT. When the camera's internal parameters are fixed and used, the 5-dimensional coordinates may be calculated from the camera's external parameters corresponding to the GT. The 3D video corresponding to the output of the 3D INVR model represents either an image rendered by the 3D INVR model in the world coordinate system based on five-dimensional coordinates, or an image in the image coordinate system corresponding to the rendered image. For example, a 3D video may be composed of multiple rendered images having different view points.

By increasing or decreasing the number of combinations of MLPs and CNNs during implementation of the 3D INVR model, the present disclosure can adjust the trade-off between the neural network's size determining the bitstream size and the fidelity of the 3D video's spatial reproducibility. The present disclosure verifies how the selection of the MLP-CNN combination of interest affects bit distortion and adaptively selects the MLP-CNN combination based on the verification results. For example, as the number of combinations of MLPs and CNNs increases, the bit rate increases and the fidelity of reproducibility increases. However, if the number of combinations increases excessively beyond a certain threshold, the fidelity of reproducibility may sharply decrease. Therefore, the video encoding apparatus implements the structure of the 3D INVR model containing various MLP-CNN combinations to find the structure providing optimal performance, and then transmits information on the 3D INVR structure providing optimal performance to the video decoding apparatus. As the 3D INVR structure providing optimal performance, the entire model structure and parameters may be transmitted, and other methods such as the following may also be used.

For example, the 3D INVR structure may be shared between the video encoding apparatus and the video decoding apparatus, while the parameters may be transmitted separately. For example, the video encoding apparatus and video decoding apparatus share a 3D INVR structure constructed differently according to numbers M, M+1, M+2, . . . , M+N of MLP-CNN combinations derived from the 3D INVR model's structure having M+N modules, including any number M of MLPs and any number N of CNNs. The video encoding apparatus selects which structure provides the optimal performance and determines the index of the selected 3D INVR structure. The video encoding apparatus transmits the index along with the trained parameters to the video decoding apparatus. The video decoding apparatus uses the received index to determine the 3D INVR structure and reconstructs the 3D INVR model by applying the decoded parameters.

As another example, the neural network compressor 120 may use a quantization parameter to adjust the size of the bitstream and reproducibility. The present disclosure verifies how the selection of the quantization parameter affects rate distortion and adaptively selects the quantization parameter based on the verification results. For example, as the value of the quantization parameter increases, the bit rate decreases. However, if the value of the quantization parameter exceeds a certain threshold, i.e., if the size of the quantization step increases, the fidelity of reproducibility may sharply decline. Therefore, the video encoding apparatus implements a 3D INVR model that uses various quantization parameters to find the quantization parameter providing optimal performance, then transmits the found quantization parameter to the video decoding apparatus.

The 3D INVR model requires camera parameters to output an arbitrary intermediate view point video between view points. As described above, camera parameters include camera's internal parameters for converting from the image coordinate system to the camera coordinate system, and external parameters specifying the camera's position and viewing direction in the world coordinate system. The camera's internal parameters include the focal length, principal point, and skew coefficient. The camera's external parameters include rotation coefficients and translation coefficients.

The video encoding apparatus may interpolate the camera's external parameters corresponding to the surrounding view points and used for training and encoding the 3D INVR model, and may use the interpolated camera's external parameters to generate new 5-dimensional coordinates representing an arbitrary intermediate view point. At this time, the camera's internal parameters are considered fixed. The video encoding apparatus may further use the new 5-dimensional coordinates and the corresponding ground truth (GT) for training the 3D INVR model. At this time, the GT corresponding to the new 5-dimensional coordinates may be generated, for example, by interpolating the GTs corresponding to the camera's external parameters used for the interpolation. Specifically, the video encoding apparatus translates the GTs corresponding to the surrounding view points into the world coordinate system by using camera parameters, then interpolates the moved GTs in the world coordinate system to generate a new GT. The video encoding apparatus may use the interpolated camera parameters to translate the new GT into the image coordinate system and thereby generate GT for the new 5-dimensional coordinates.

The video encoding apparatus determines the upper and lower bounds of the components of the 5-dimensional coordinates used for training and encoding the 3D INVR model, thereby defining the input range of the 3D INVR model. Namely, the learned 3D INVR model may generate a 3D video corresponding to 5-dimensional coordinates within the input range. The video encoding apparatus transmits the input range of the 3D INVR model to the video decoding apparatus. Alternatively, a preset input range may be used according to an agreement between the video encoding apparatus and the video decoding apparatus.

Meanwhile, while 3D INVR is used to reproduce three-dimensional spatial information, the video encoding apparatus may further transmit existing depth information (depth map) also, and the video encoding apparatus and video decoding apparatus may use the depth information together. The video encoding apparatus may compress the depth information with lossy/lossless compression and then may transmit the compressed depth information to the video decoding apparatus. Alternatively, the video decoding apparatus may generate/derive the depth information without transmission of the same from the video encoding apparatus.

In conclusion, the video encoding apparatus transmits, as supplementary information, the camera parameters used for training and encoding the INVR model, and the quantization parameter applied to compress the 3D INVR model. Additionally, the video encoding apparatus may transmit, as supplementary information, information on the 3D INVR model structure, the input range of the 3D INVR model, and information related to depth information. Here, the information related to depth information may include syntax indicating whether depth information is to be transmitted.

The video decoding apparatus illustrated in FIG. 2 uses the neural network decompressor 210 to decode the parameters of the 3D INVR model from the bitstream. For example, the 3D INVR model may be reconstructed by using the decoding pipeline illustrated in FIG. 10. The video decoding apparatus decodes, as supplementary information, the camera parameters used for training and encoding the INVR model, and the quantization parameter applied to compress the INVR model. The video decoding apparatus decodes, as supplementary information, the information on the 3D INVR model structure, the input range of the 3D INVR model, and the information related to the depth information. Furthermore, if depth information is transmitted according to syntax indicating whether depth information is to be transmitted, the video decoding apparatus further decodes the depth information.

The 3D INVR decoder 110 uses the reconstructed 3D INVR model to generate 3D video at various view point indices. After obtaining an arbitrary intermediate view point, the video decoding apparatus inputs the arbitrary intermediate view point into the 3D INVR model to generate the 3D video corresponding to that view point.

For example, when using a NeRF-based 3D INVR model, the video decoding apparatus uses the 5-dimensional coordinates as mentioned above, as the input index representing an arbitrary intermediate view point. For each 5-dimensional coordinate, the 3D INVR model regenerates an image viewed along the viewing direction (θ,φ) in the (x,y,z) plane. At this time, the 5-dimensional coordinates representing an arbitrary intermediate view point are bound to be present within the input range. For example, when the 5-dimensional coordinates are not present within the input range, the video decoding apparatus may not provide the 3D video.

To convey the above-described supplementary information, an INVR parameter set (IPS) containing the following syntax elements is defined.

The information on the 3D INVR model structure includes syntax defining the size and number of the MLPs and CNNs constituting the model, syntax defining the structure of the edges composing the model, syntax defining the format and precision of the parameters composing the model, syntax defining upper and lower bounds on the size and number of the MLPs and CNNs constituting the model, syntax defining upper and lower bounds on the number of edges composing the model, syntax defining upper and lower bounds on the precision of the parameters composing the model, and the like.

Information on camera parameters includes the aforementioned internal parameters and camera's external parameters.

Information on the quantization parameter of the neural network compressor 120 includes syntax defining upper and lower bounds on the available size of the quantization parameter.

The information related to the depth information includes syntax indicating whether the depth information is to be transmitted.

Information on the input range includes syntax defining the upper and lower bounds of the view point.

Hereinafter, a method is described for adjusting the trade-off between the fidelity of the 3D video's spatial reproducibility and the size of the neural network determining the bitstream size by increasing or decreasing the number of combinations of MLPs and CNNs. Depending on the selection of the compression description method described below, or a combination of multiple compression methods, the video encoding apparatus may adaptively compress the 3D INVR model.

The video encoding apparatus may determine, by adjusting the number of MLP modules or CNN modules, the overall performance of the INRV model, the performance of the compressed INRV model, and the training speed. As the number of modules increases, the size of the 3D INRV model grows, and the fidelity of reproducibility increases in a convex figure. Therefore, the video encoding apparatus may find an optimum point for the performance and size of the 3D INRV model. Furthermore, by adaptively adjusting the number of modules according to the task, the video encoding apparatus may derive task-specific optimal results. When high-quality output is required, the video encoding apparatus constructs the 3D INRV model by increasing the number of modules. However, increasing the number of modules raises the complexity of the INRV model, potentially requiring longer training times. If the number of modules increases excessively, the fidelity of reproducibility may sharply decline. Furthermore, compared to light-duty models, the more complex the 3D INRV model, the lower its performance when compressing at the same bits per pixel (bpp). Therefore, when a low bitrate is required for compression convenience or to increase training speed, the video encoding apparatus reduces the number of modules. Here, bpp may be defined as the value obtained by dividing the bitstream generated by encoding the learned INVR model by the resolution of the 3D video provided by the video encoding apparatus.

As one example, the above-described NeRF may be composed of ten consecutive MLP modules. In another example, NeRV may be composed of one MLP and five CNNs. In yet another example, Hybrid Neural Representation for Videos (HNeRV) is composed of five combinations of CNNs and MLPs plus six additional CNNs. As mentioned, the performance of the 3D INRV model increases in a convex figure as its size increases. Therefore, the video encoding apparatus can increase the number of modules until performance converges. For example, adding a CNN in the middle of the 3D INRV model can improve its performance. As confirmed empirically, the performance of the 3D INRV model improves as the number of CNNs added in the middle increases up to 10.

The following describes a method of adaptively reducing the number of MLP and CNN layers, or the number of parameters.

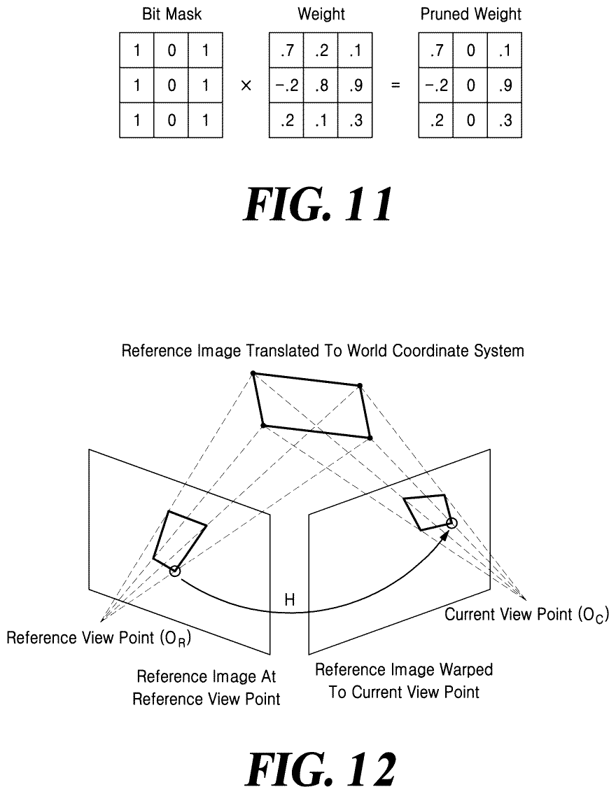

FIG. 11 is a diagram illustrating pruning using a bit mask, according to at least one embodiment of the present disclosure.

During the training process of the 3D INRV model, the video encoding apparatus may reduce the number of parameters by using pruning. As one example of pruning, a bit mask, i.e., a binary mask composed of 0s and 1s, is used. The video encoding apparatus learns the bit mask and then multiplies it by the parameters of the INRV model, as shown in the example of FIG. 11. The bit mask determines the weights used for training and is updated according to the backpropagation of the loss function.

Another example of pruning involves setting, among the parameters of the 3D INRV model, a parameter to zero if its absolute value falls below a predefined threshold. Another example of pruning involves zero setting weights at positions within the parameter matrix, which deviate from predefined locations. For example, within a K×L parameter matrix, only parameters located within an S×T region may be retained, with the other parameters pruned to zero where K, L, S, T are arbitrary positive integers satisfying S≤K and T≤L.

During the training process of the 3D INRV model, the video encoding apparatus uses a loss function that includes an element for adjusting the bitstream size by adjusting the parameter sizes, in addition to the video spatial fidelity. For example, the parameters of the 3D INRV model may be adjusted by using a sparsity loss. The sparsity loss is defined in Equation 4.

$${L}_{s p a r s i t y} ( w ) = \frac{{\vert w \vert}_{1}}{{\vert w \vert}_{2}} + \frac{{\vert w \vert}_{2}^{2}}{{\vert w \vert}_{1}} \qquad [ Equation 4 ]$$

In Equation 4, |w|₁ and |w|₂ represent the L1 norm and L2 norm, respectively.

By measuring the rate distortion of the 3D INRV model trained based on a loss function incorporating a sparsity loss, the video encoding apparatus determines the optimal number of MLP and CNN layers, or the optimal number of parameters. The sparsity loss shown in Equation 4 is merely one example, and various other methods of calculating sparsity loss may also be used.

After training the 3D INRV model, the neural network compressor 120 compresses the parameters of the 3D INRV model, for example, by using the encoding pipeline illustrated in FIG. 9. The neural network compressor 120 uses parameters for sparsification, pruning, unification, local scaling, and the like to adjust the trade-off between the bitstream size and the final performance of the INVR model. For example, after the model parameters are organized into a matrix, the parameter matrix may be divided into an arbitrary number of sub-blocks. The unification refers to the operation of setting a single parameter value for some sub-blocks. The local scaling refers to the operation of scaling the parameter values of some sub-blocks within the parameter matrix divisions.

As an example, the video encoding apparatus may transmit IPS by using lossless compression.

Hereinafter, a technique is described for generating video of an arbitrary view point requested by the decoder side by using an adaptive 3D INVR model and enhancing its quality. The video decoding apparatus enhances the image quality of the current view point by referencing images of other view points relative to the current view point, utilizing the redundancy between frames of different view points. The present disclosure provides both inter-RGB-pixel referencing and referencing at the feature level of the 3D INVR model. As one example, for referencing, the video decoding apparatus uses depth information to place the reference camera coordinate system in the world coordinate system, then converts the world coordinate system into the camera coordinate system of the desired view point. At this time, the video decoding apparatus decodes and then uses the depth information, which is supplementary information transmitted by the video encoding apparatus. Alternatively, the video decoding apparatus may derive and then use the depth information. As another example, the video decoding apparatus may transform the view point of the reference image by using camera parameters.

FIG. 12 is a diagram illustrating warping of a reference image, according to at least one embodiment of the present disclosure.

For example, the video decoding apparatus enhances the image quality at the current view point by warping RGB pixels. As illustrated in FIG. 12, warping of RGB pixels represents the process of using corresponding depth information (or camera parameters) to translate the coordinate system of the reference image to the world coordinate system, and then converting the world coordinate system into the coordinate system of the current image. The video decoding apparatus uses the above-described warping to generate a reference image for the current view point. The video decoding apparatus generates an enhanced current image by generating a weighted sum of the reference image warped to the current view point and the current image. Here, the current image represents the image corresponding to the current view point, and the reference image represents the image corresponding to the reference view point. In the illustration of FIG. 12, H indicates the translation of RGB pixels within the reference image based on warping.

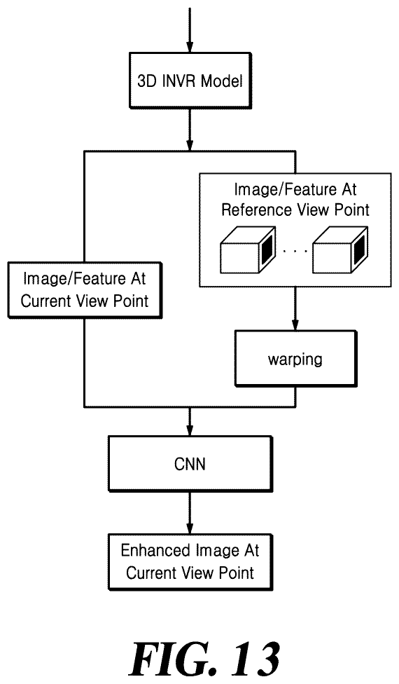

FIG. 13 is a diagram illustrating warping of a reference image/feature, according to at least one embodiment of the present disclosure.

As another example, the video decoding apparatus may use feature warping to enhance the image quality of the current view point. In this case, the video decoding apparatus performs warping between view points at the feature level of the 3D INVR model. The feature warping method may be based on a neural network (NN), by using an MLP, or it may utilize a translation between the world coordinate system and the camera coordinate system based on depth information (or camera parameters), similar to RGB warping. For example, the last MLP stage in a NeRF model may be used as the reference feature. The NeRV block, corresponding to the last stage of the NeRV model, may be used as the reference feature. For instance, as shown in the example of FIG. 13, the warped reference feature/image by using a CNN may be fused with the current feature/image. In the illustration of FIG. 13, warping denotes the process of converting the coordinates of the reference feature/image to the coordinates of the current feature/image. The video decoding apparatus may concatenate the warped reference feature/image and the current feature/image, then input the concatenated feature to the CNN.

Group of INVR (Gol) denotes the method of constructing 3D INVR based on view point and/or time. The video encoding apparatus transmits IPS per Gol. The video decoding apparatus may decode IPS per Gol to establish the 3D INVR model and related parameters.

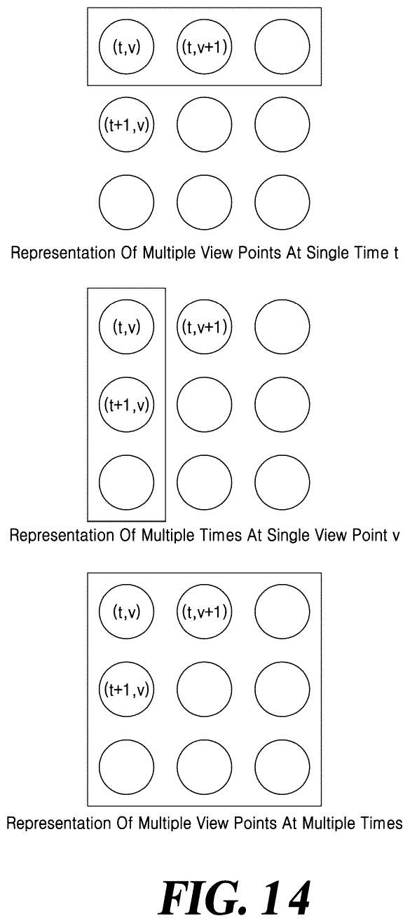

FIG. 14 is a diagram illustrating the definition of a Group of INVR (Gol) according to at least one embodiment of the present disclosure.

As illustrated in FIG. 14, in one example, a Gol may be configured such that a single 3D INVR model represents multiple view points at a single time t. In another example, a Gol may be configured such that a single 3D INVR model represents multiple times at a single view point v. In yet another example, the Gol may be configured such that a single 3D INVR model represents multiple view points at multiple times or multiple times at multiple view points.

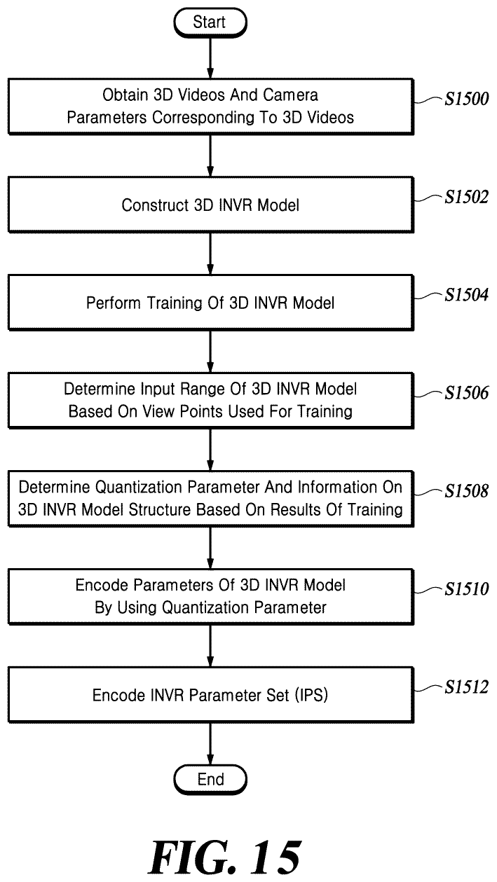

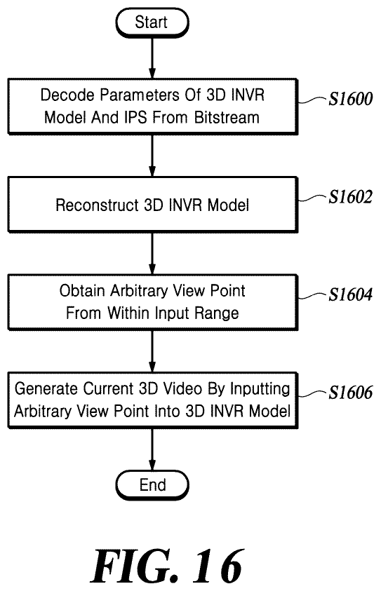

Hereinafter, by using the illustrations of FIGS. 15 and 16, methods of encoding or reconstructing 3D INVR-based 3D video are described.

FIG. 15 is a flowchart of a method of encoding 3D videos by the video encoding apparatus, according to at least one embodiment of the present disclosure.

The video encoding apparatus obtains 3D videos and camera parameters corresponding to the 3D videos (S1500).

The video encoding apparatus constructs a 3D INVR model (S1502).

Here, the 3D INVR model includes a multi-layer perceptron and a CNN. The video encoding apparatus may construct the structure of the 3D INVR model differently based on, for example, the size and number of the MLPs and CNNs.

The video encoding apparatus performs training of the 3D INVR model by using view points corresponding to camera parameters and 3D videos corresponding to camera parameters (S1504).

As an example, when NeRF is used as the 3D INVR model, the elements constituting the view points represent 5-dimensional coordinates. Here, the 5-dimensional coordinates include world coordinates (x, y, z) and viewing direction (0, q). The video encoding apparatus may extract the constituent elements of the corresponding view point by using the camera parameters corresponding to each 3D video.

The video encoding apparatus inputs the view points to the 3D INVR model to generate an output. The video encoding apparatus calculates the difference between the output of the 3D INVR model and the ground truth (GT). Here, the 3D videos obtained in the above-described step are used as the GT. The video encoding apparatus updates the parameters of the 3D INVR model based on a loss function that includes the above-described difference and a sparsity loss (e.g., as defined by Equation 4).

During the training process, the video encoding apparatus may reduce the number of parameters of the 3D INVR model by using pruning.

The video encoding apparatus determines the input range of the 3D INVR model based on the view points used for training (S1506).

The video encoding apparatus determines upper and lower bounds for each of elements constituting the view points used for training the 3D INVR model and thereby determines the input range of the 3D INVR model.

The video encoding apparatus determines the quantization parameter, and information on the 3D INVR model structure based on the results of the training (S1508).

The video encoding apparatus may select the 3D INVR model structure that is optimal in terms of rate distortion and training speed. Furthermore, the video encoding apparatus may adaptively determine the quantization parameter in terms of rate distortion optimization.

The video encoding apparatus encodes the parameters of the 3D INVR model by using the quantization parameter (S1510). For example, the video encoding apparatus may compress the parameters of the 3D INVR model by using an encoding pipeline as illustrated in FIG. 9.

The video encoding apparatus encodes the IPS (S1512).

Here, the INVR parameter set (IPS) includes, as supplementary information, quantization parameter, information on the 3D INVR model structure, and information on the input range of the 3D INVR model. Furthermore, the IPS may additionally include, as supplementary information, camera parameters and syntax indicating whether depth information (depth map) is to be transmitted.

If the syntax indicating the transmission status of depth information indicates transmission of the depth information, the video encoding apparatus may additionally encode the depth information.

FIG. 16 is a flowchart of a method of reconstructing the current 3D video by the video decoding apparatus, according to at least one embodiment of the present disclosure.

The video decoding apparatus decodes the parameters of the 3D INVR model and the INVR parameter set (IPS) from the bitstream (S1600).

The IPS includes, as supplementary information, quantization parameter, information on the 3D INVR model structure, and information on the input range of the 3D INVR model. Additionally, the IPS may further include, as supplementary information, camera parameters and syntax indicating whether depth information (depth map) is to be transmitted.

The video decoding apparatus reconstructs the 3D INVR model by using the parameters of the 3D INVR model and the quantization parameter to conform to the information on the 3D INVR model structure (S1602).

Here, the 3D INVR model includes a multi-layer perceptron (MLP) and a convolutional neural network (CNN). The video decoding apparatus may, for example, determine the size and number of the MLPs and CNNs by using the information on the 3D INVR model structure.

The video decoding apparatus obtains an arbitrary view point within the input range (S1604).

The video decoding apparatus inputs the arbitrary view point into the 3D INVR model to generate the current 3D video (S1606).

As an example, the video decoding apparatus generates a reference image/feature for the current view point by using warping. Here, warping refers to the process of translating the coordinate system of the reference image/feature into the world coordinate system by using camera parameters, and then converting the world coordinate system of the reference image/feature into the coordinate system of the current 3D video. Subsequently, the video decoding apparatus generates an enhanced current 3D video by performing a weighted sum of the warped reference image/feature and the current 3D video/feature.

As another example, when the syntax indicating transmission status of depth information (depth map) indicates transmission of the depth information, the video decoding apparatus decodes the depth information. The video decoding apparatus generates a reference image/feature for the current view point by using warping. Here, warping refers to the process of translating the coordinate system of the reference image/feature to the world coordinate system by using the depth information, and then converting the world coordinate system of the reference image/feature to the coordinate system of the current 3D video. Subsequently, the video decoding apparatus generates an enhanced current 3D video by performing a weighted sum between the warped reference image/feature and the current 3D video/feature.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

110: 3D INVR encoder
120: neural network compressor
210: neural network decompressor
220: 3D INVR decoder

### CROSS-REFERENCE TO RELATED APPLICATIONS

This application claims priority to and the benefit of Korean Patent Application No. 10-2023-0066090 filed on May 23, 2023, and Korean Patent Application No. 10-2024-0061136, filed on May 9, 2024, the entire contents of each of which are incorporated herein by reference.

1. A method for reconstructing a current three-dimensional (3D) video by a video decoding apparatus, the method comprising:
decoding, from a bitstream, parameters of a 3D implicit neural video representation model (3D INVR model) and an INVR parameter set (IPS) that comprises a quantization parameter, information on a structure of the 3D INVR model, and information on an input range of the 3D INVR model;
reconstructing the 3D INVR model by using the parameters of the 3D INVR model and the quantization parameter to conform to the information on the structure of the 3D INVR model that comprises a multi-layer perceptron (MLP) and a convolutional neural network (CNN);
obtaining an arbitrary view point from within the input range; and
generating the current 3D video by inputting the arbitrary view point to the 3D INVR model.

2. The method of claim 1, wherein reconstructing the 3D INVR model comprises:
determining sizes and numbers of MLPs and CNNs by using the information on the structure of the 3D INVR model.

3. The method of claim 1, wherein the information on the structure of the 3D INVR model comprises:
a syntax that defines sizes and numbers of MLPs and CNNs, and a syntax that defines a format and a precision of the parameters of the 3D INVR model.

4. The method of claim 1, wherein the IPS further comprises:
camera parameters.

5. The method of claim 4, further comprising:
generating a reference image in respect of a current view point by using warping that represents a process of translating a coordinate system of the reference image to a world coordinate system by using the camera parameters and converting the world coordinate system of the reference image into a coordinate system of the current 3D video; and
generating an enhanced current 3D video by performing a weighted sum of the reference image that underwent the warping and the current 3D video.

6. The method of claim 4, further comprising:
generating a reference feature in respect of a current view point by using warping that that represents a process of translating a coordinate system of the reference feature to a world coordinate system by using the camera parameters and converting the world coordinate system of the reference feature into a coordinate system of a feature of the current 3D video; and
generating an enhanced current 3D video by performing a weighted sum of the reference feature and the feature of the current 3D video.

7. The method of claim 1, wherein the IPS further comprises:
a syntax indicating whether a depth map is to be transmitted.

8. The method of claim 7, further comprising:
checking whether the syntax indicates that the depth map is to be transmitted; and
when the syntax indicates that the depth map is transmitted, decoding the depth information.

9. The method of claim 8, further comprising:
generating a reference image in respect of the current view point by using warping that represents a process of translating a coordinate system of the reference image to a world coordinate system by using the depth map and converting the world coordinate system of the reference image into a coordinate system of the current 3D video; and
generating an enhanced current 3D video by performing a weighted sum of the reference image that underwent the warping and the current 3D video.

10. The method of claim 1, wherein decoding the IPS comprises:
decoding the IPS for each Group of Interest (Gol) that is configured to make a single 3D INVR model represent multiple view points at a single time.

11. A method for encoding three-dimensional (3D) videos by a video encoding apparatus, the method comprising:
obtaining the 3D videos and camera parameters corresponding to the 3D videos;
constructing a 3D implicit neural video representation model (3D INVR model) that comprises a multi-layer perceptron (MLP) and a convolutional neural network (CNN);
training the 3D INVR model by using view points corresponding to the camera parameters and using 3D videos corresponding to the camera parameters;
determining an input range of the 3D INVR model based on the view points used for the training;
determining a quantization parameter and information on a structure of the 3D INVR model based on results of the training;
encoding parameters of the 3D INVR model by using the quantization parameter; and
encoding an INVR parameter set (IPS) that comprises the quantization parameter, the information on the structure of the 3D INVR model, and information on the input range of the 3D INVR model.

12. The method of claim 11, wherein the IPS further comprises:
the camera parameters and a syntax indicating whether a depth map is to be transmitted.

13. A method of claim 11, wherein constructing the structure the 3D INVR model comprises:
constructing the structure of the 3D INVR model differently based on sizes and numbers of the MLP and the CNN, and
wherein determining the information on the structure of the 3D INVR model comprises:
selecting the 3D INVR model by a structure that is optimal in terms of rate distortion and training speed; and
including syntax elements indicating the structure of the 3D INVR model in the information on the structure of the 3D INVR model.

14. The method of claim 11, wherein determining the quantization parameter comprises:
adaptively determining the quantization parameter in terms of rate-distortion optimization.

15. The method of claim 11, wherein determining the input range of the 3D INVR model comprises:
determining upper and lower bounds for each of elements constituting the view points used for training the 3D INVR model.

16. The method of claim 11, wherein training the 3D INVR model comprises:
calculating a difference between an output of the 3D INVR model and a ground truth (GT) by using the 3D videos as the GT;
updating the parameters of the 3D INVR model based on a loss function comprising the difference and a sparsity loss.

17. The method of claim 11, wherein training the 3D INVR model comprises:
reducing a number of the parameters of the 3D INVR model by using pruning.

18. A method for providing video data to a video decoding apparatus, the method comprising:
encoding the video data into a bitstream; and
transmitting the bitstream to the video decoding apparatus,
wherein encoding the video data comprises:
obtaining 3D videos and camera parameters corresponding to the 3D videos;
constructing a 3D implicit neural video representation model (3D INVR model) that comprises a multi-layer perceptron (MLP) and a convolutional neural network (CNN);
training the 3D INVR model by using view points corresponding to the camera parameters and using 3D videos corresponding to the camera parameters;
determining an input range of the 3D INVR model based on the view points used for training;
determining a quantization parameter and information on a structure of the 3D INVR model based on results of the training;
encoding parameters of the 3D INVR model by using the quantization parameter; and
encoding an INVR parameter set (IPS) that comprises the quantization parameter, the information on the structure of the 3D INVR model, and information on the input range of the 3D INVR model.
